(19) United States
(12) Patent Application Publication
(10) Pub. No.: US 2025/0196272 A1
(43) Pub. Date: Jun. 19, 2025

(54) Bauer exothermic cutting rod

(71) Applicant: John David Bauer, Inman, SC (US)

(72) Inventor: John David Bauer, Inman, SC (US)

(21) Appl. No.: 18/445,657

(22) Filed: Dec. 14, 2023

(51) Int. Cl. B23K 35/02; B23K 35/22; B32B 1/08

(52) U.S. Cl. CPC B23K 35/0216; B23K 35/228; B32B 1/08

(57) ABSTRACT

An Exothermic Cutting Rod comprised of three concentric tubes coupled together with a Tri-Point crimping pattern. This combination allows the Exothermic Cutting Rod to release a steady and regulated chemical reaction and oxygen. This invention greatly improves the cutting capacity and reduces the fuel requirements per cut.

### BACKGROUND

Exothermic cutting rods are tools used for a process known as exothermic cutting, which is a type of thermal cutting method. The term “exothermic” refers to a chemical reaction that releases energy in the form of heat. Exothermic cutting rods are commonly used for cutting through metals, particularly in situations where other methods such as oxy-fuel cutting may not be practical or efficient.

Generally, Exothermic cutting rods are typically composed of a mixture of metal powders, reducing agents, and other components. Common materials include aluminum, iron oxide, and other reactive metals. These components are carefully blended to create a mixture that undergoes an exothermic reaction when ignited. To initiate the cutting process, the end of the rod is ignited using a spark or a flame. This can be done using a special igniter connected to a 12-volt battery. Once ignited, the exothermic reaction begins. The main exothermic reaction involves the consumable steel rod and oxygen flowing through the rod. This reaction is highly exothermic, meaning it releases a significant amount of heat. The intense heat generated by the exothermic reaction melts the material being cut and the pressure of the flowing oxygen pushes the molten material away producing a kerf. The intense heat generated by the exothermic reaction allows the exothermic cutting rod to cut, pierce, or gouge any ferrous or non-ferrous metals or other materials.

Each Exothermic cutting rod has at least one crimp. The crimp in an exothermic cutting rod refers to a specific feature at one end of the rod or throughout the rod. The crimp serves as a way to hold and secure the ignition material or rod components in place. It is an important part of the design to ensure a reliable and consistent ignition of the rod. The design of the crimp helps control the ignition process. By concentrating the ignition material evenly along the length of the rod, the exothermic reaction is more likely to initiate uniformly and efficiently.

The design of the crimp in an exothermic cutting rod is crucial. The design controls ignition, can provide a consistent and less turbulent flow of oxygen creating a uniform exothermic reaction, and reliability in performance.

The crimp concentrates the ignition material evenly along the length of the rod. This concentration helps ensure a controlled and uniform ignition when exposed to a spark or flame. A controlled ignition is essential for the predictable and consistent initiation of the exothermic reaction throughout the length of the rod.

A well-designed crimp contributes to a uniform progression of the exothermic reaction along the rod. This is important for achieving a consistent release of heat and molten metal throughout the cutting process. Uniformity in the reaction helps maintain a steady cutting speed and promotes a clean and effective cut through the material.

A refined crimp contributes to the overall reliability and consistency of the exothermic cutting rod. Consistent performance is essential for users who rely on the rods for various applications, including emergency cutting situations, where the performance of the rod can be critical.

The most popular kinds of Exothermic Cutting Rods use either wire in tube design or a wrapped steel sheet design. The wire in tube design is where solid wires are inserted into the tubes. The wrapped steel sheet design is where steel sheet is wrapped together into a rod with the final seam joint is filled with a flux compound. There are hybrid versions of this with wrapped steel sheet with wire cable stranded through the wrapped steel sheet, too.

The market for Exothermic Cutting Rods is always looking for a new and improved Exothermic Cutting Rod that improves the control over the ignition and provides a uniform and consistent burn throughout its use. Usually, creators will have to give up some aspects over others with their design. A crimp designed to maximize flow of oxygen can be too powerful. Maximizing the flow of oxygen can devastate the Exothermic Cutting Rod as that design decreases the stability of the exothermic cutting rod. However, a crimp designed to maximize the life of the Exothermic Cutting Rod reduces the power of the exerted exothermic reaction by reducing oxygen flow throughout the Exothermic Cutting Rod. Cut times that are too short, causes the operator to have frequent rod change outs and reduce linear cut. Cut times that are too long, creating operator fatigue and excessive oxygen use. Rod crimp design and positions cause venturi related effects. The pressure of the oxygen flow around the crimps causes turbulence in the oxygen flow. This can cause an uneven burn rate with the outer rod tube and inner tubes. Producing uneven kerfs and reduced cutting efficiency. Additionally, a problem with some wrapped steel sheet designs that integrated the wire cable is that they can produce caustic gasses when burned, which endangers the user.

The below disclosed invention provides for a design that both maximizes the oxygen flow and provides for a design that gives it the stability to last longer and with more consistency than its contemporaries.

### SUMMARY OF INVENTION

The present invention is an Exothermic Cutting Rod with a tube-in-tube design and a three-point crimp can provide for an increased fuel to oxygen burn ratio, increased rod cut lengths, consistently powerful burns, decreased time to cut, more efficient oxygen use, and greater cost effectiveness. The present invention utilizes compressed pure oxygen (oxidizer) and low carbon steel tubes as fuel. When the rod is ignited the oxygen and burning steel can produce temperatures between 8,000-10,000 ° F.

The present invention requires a tube-in-tube design having several Concentric Tubes and space allowed around the surfaces of the inner tubes to permit oxygen to pass efficiently forward to the ignited end of the rod. The diameters and wall thicknesses are. calibrated to produce optimum fuel to oxygen ratio.

The rods are crimped in succession starting with two rods crimped to form one unit and then crimped to the next larger tube in succession until the outer last tube is crimped to form the completed rod. The rods are crimped in a Tri-Point Pattern to keep tubes roughly concentrically centered within in each other assuring for minimal disruption of oxygen flowing through the tubes allowing for a uniform burn. The Tri-Point crimps are of two specific types: Safety Crimp and Place Keeping Crimp. A Safety Crimp procedure creates indents in the rod deep enough to create pressure or force as to lock the tube components together to keep proper proportions of oxygen available to the tube components. There is only one Safety Crimp, and that, when placed on a 48-inch tube, is placed 3.5 inches from the end that inserts into the torch head. The Safety Crimp is mandatory.

The Place Keeping Crimps create indents that are only deep enough to center the tubes keeping the tube walls from sagging or restricting the flow of oxygen beyond where the crimp itself is placed. This supports consistent oxygen flow through and around all the tubes. The Place Keeping Crimp also keeps the rods from movement during higher oxygen pressures. Place Keeping Crimps are placed throughout the length of the rods at different intervals depending on length and diameter of the tubes. Tube crimps cause venturi related effects. The pressure of the oxygen flow around the crimps causes turbulence. This is a major cause of reduced cutting efficiency. The Tri-Point Pattern maximizes oxygen flow and allows for a significant reduction of oxygen turbulence.

### BRIEF DESCRIPTION OF THE DRAWINGS

FIG. 1 depicts a horizontal view of one embodiment of the Exothermic Cutting Rod with the sides of the Outer Tube and Inner Tube with a missing section to be able to see within the Outer and Inner Tubes.

FIG. 2 depicts a concentric view of the Ignition End of the Exothermic Cutting Rod.

FIG. 3 depicts a concentric view of the Torch End of the Exothermic Cutting Rod.

FIG. 4 depicts a cross-sectional and concentric view of the Outer Safety Crimp and the Inner Safety Crimp within the Exothermic Cutting Rod.

FIG. 5 depicts a cross-sectional and concentric view of the Outer Place-Keeping Crimp and the Inner Place-Keeping Crimp within the Exothermic Cutting Rod.

FIG.6 shows a perspective view of one embodiment of the Exothermic Cutting Rod

### DETAILED DESCRIPTION OF THE INVENTION

The Exothermic Cutting Rod is made of a three-tube system. Each tube is a cylindrical-shaped object with a hollow inside. In some embodiments, the tubes are an SAE J526 low carbon steel. The three-tube system has a Center Tube 2, an Inner Tube 3 and an Outer Tube 4, collectively the Concentric Tubes. The Concentric Tubes are roughly concentric with one another and run parallel with them. The positioning of the Concentric Tubes is that the Center Tube 2 being the inside the Inner Tube 3 and the Outer Tube 4, the Inner Tube 3 being within the Outer Tube 4, and the Outer Tube 4 having the Inner Tube 3 and Center Tube 2 within it.

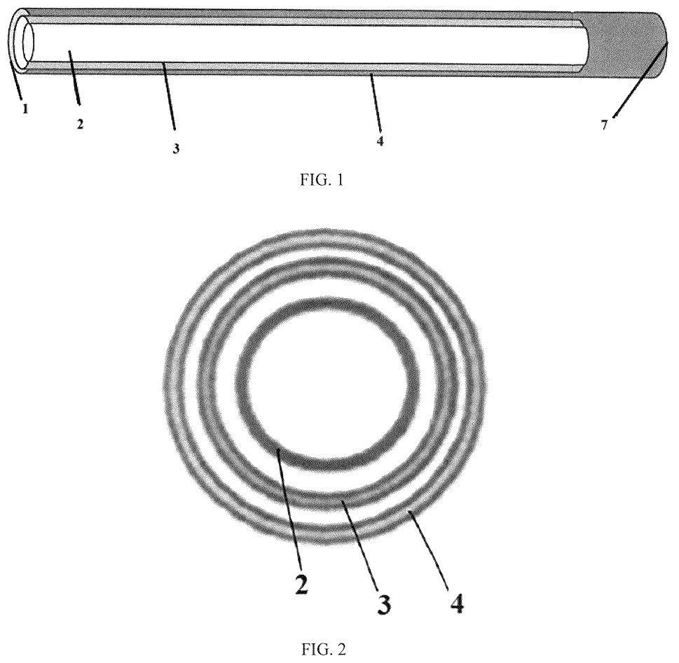

FIG. 1 shows one embodiment of the Concentric Tubes arranged where the Center Tube 2 is within the Inner Tube 3, which in turn is within the Outer Tube 4. Although there could in theory be more tubes that could be added to this invention, the introduction of a fourth or more tubes would greatly diminish the efficiency of the Exothermic Cutting Rod, thereby reducing the cutting power per amount of fuel consumed by the Exothermic Cutting Rod and increasing the burn rate of the Exothermic Cutting Rod itself. Additionally, FIG. 1 shows the Torch End 7 and the Ignition End 1 of the Exothermic Cutting Rod.

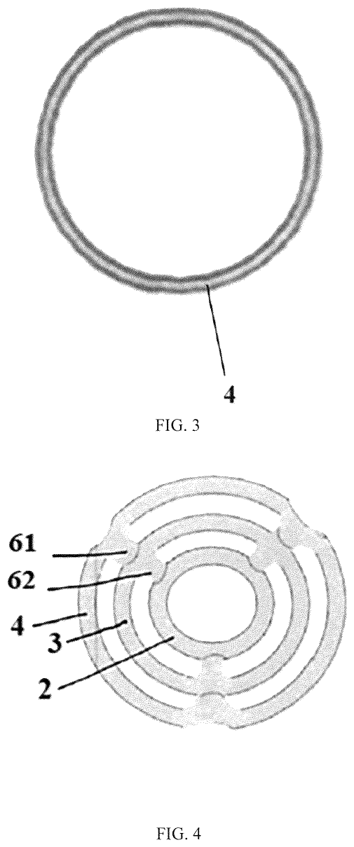

FIGS. 2 and 3 show the Ignition End 1 of the Exothermic Cutting Rod and the Torch End 7 of the Exothermic Cutting Rod, respectively. With the design of the Exothermic Cutting Rod, the Ignition End 1 of this invention is open and easily allows the flow of oxygen and increases the burn capacity versus other Exothermic Cutting Rods on the market. Additionally, the Torch End 7 is open and only has the Outer Tube 4 of the Concentric Tubes. This design of the Torch End 7 provides for a maximum amount of oxygen to be blown through the Exothermic Cutting Rod. Additionally, the lack of the Inner Tube 3 and Center Tube 2 serves as a safety feature as the user approaches the lack of the Inner Tube 3 and Center Tube 2, then that is a sign that the Exothermic Cutting Rod needs to be used and any further use would be dangerously close to the oxygen source.

FIG. 4 shows the Safety Crimps, both the Outer Safety Crimp 61 and the Inner Safety Crimp 62. The Safety Crimps are indents into the surfaces of the Inner Tube 3 and the Center Tube 2 from the Outer Tube 4 and Inner Tube 3, respectively. This prevents the Concentric Tubes from sliding back and forth and acts as the last Crimp between the Ignition End 1 and the Torch End 7. There are three Outer Safety Crimps 61 and three Inner Safety Crimps 62. The Outer Safety Crimps 61 are formed in a Tri-Point Pattern where the three crimps are made roughly equidistant around the Outer Tube. Additionally, the Inner Safety Crimps 62 are formed in a Tri-Point Patter where the crimp is made roughly a third of a way around the Inner Tube. This Tri-Point Pattern design provides enough structural support to the Concentric Tubes not to dislodge or break apart, while also providing a design that maximizes the amount oxygen flowing through the Exothermic Cutting Rod. This Tri-Point Pattern design is a critical component of this invention.

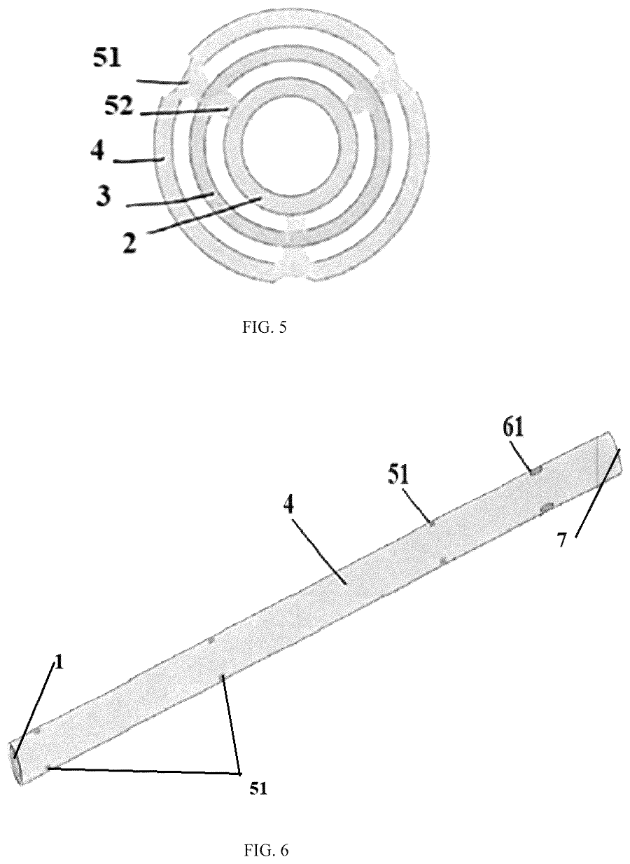

FIG. 5 shows the Place-Keeping Crimps, both the Outer Place-Keeping Crimp 51 and the Inner Place-Keeping Crimp 52. The Safety Crimps are indents into the surfaces of the Inner Tube 3 and the Center Tube 2 from the Outer Tube 4 and Inner Tube 3, respectively. The Place-Keeping Crimps provide structural stability for the Exothermic Cutting Rod. There are at least three Outer Place-Keeping Crimps 51 and at least three Inner Place-Keeping Crimps 52. However, although there are at least three, it is best practice that the each set of Outer Place-Keeping Crimps 51 should be three, so the total number of Outer Place-Keeping Crimps 51 should be divisible by three. Similarly, it is best practice that the each set of Inner Place-Keeping Crimps 52 should be three, so the total number of Inner Place-Keeping Crimps 52 should be divisible by three. Similar to the Safety Crimps, the Place-Keeping Crimps are also created in a Tri-Point Pattern as shown in FIG. 5. The Outer Place-Keeping Crimps 51 are formed in a Tri-Point Pattern where the crimp is made roughly a third of a way around the Outer Tube 4. Additionally, the Inner Place-Keeping Crimps 52 are formed in a Tri-Point Patter where the crimp is made roughly a third of a way around the Inner Tube. This Tri-Point Pattern design provides enough structural support to the Concentric Tubes not to dislodge or break apart, while also providing a design that maximizes the amount oxygen flowing through the Exothermic Cutting Rod. This Tri-Point Pattern design is a critical component of this invention.

FIG. 6 shows the view of the outside of the Exothermic Cutting Rod. The Outer Tube 4 of the Exothermic Cutting Rod has the Torch End 7 and the Ignition End 1. There are three sets of three Outer Place-Keeping Crimps 51 and a single set of three Outer Safety Crimps 61. The location of the Safety Crimps is always towards the Torch End 7 as having a Inner Place-Keeping Crimp 52 would lower the structural integrity of the Exothermic Cutting Rod as the Inner Place-Keeping Crimp 52 would not support the initial chemical reaction as greatly as the Inner Safety Crimp 62 would. The Safety Crimps will be performed in the Tri-Point pattern shown in FIG. 4 either at the end of the Inner Tube 3 and the Center Tube 2 where the Outer Tube 4 continues to run until the Torch End 7 or right before the end of the Inner Tube 3 and Center Tube 2. The Place-Keeping Crimps will be placed either at regular intervals or irregular intervals. In some embodiments, there are a set of six Place-Keeping Crimps in one spot, with three being Outer Place-Keeping Crimps and three being Inner Place-Keeping Crimps such as in the Tri-point Patter shown in FIG. 5.

For the invention to be supported with the most common hardware for Exothermic Cutting Rods, the Concentric Tubes should have the following Outer Diameters: The Center Tube should have an Outer Diameter of 0.275 inches to 0.290 inches. The Outer Tube should have an Outer Diameter of 0.484 inches to 0.500 inches. The Inner Tube should have an Outer Diameter of 0.378 inches to 0.393 inches. If the most common hardware is not being used and a bigger or smaller Exothermic Cutting Rod is needed, then the Outer Diameter should always have the following ratio: The Outer Diameters of the Outer Tube versus the Center Tube should be roughly 66.8% to 81.8% greater in its Outer Diameter, while the Inner Tube should be roughly 30.3% to 42.9% greater in its Outer Diameter than the Center Tube.

For the invention to be supported with the most common hardware, i.e. for a ½ inch diameter Exothermic Cutting Rods, the Concentric Tubes should have the following Outer Diameters: The Inner Tube should have a wall thickness of 0.031 inches to 0.039 inches. The Outer Tube and the Center Tube should have a wall thickness of roughly 0.028 inches to 0.032 inches. However, for greater fuel to oxygen efficiency, the Inner Tube should be thicker than the Outer Tube and the Center Tube. If the most common hardware is not being used and a bigger or smaller Exothermic Cutting Rod is needed, then the wall thickness should always have the following ratio: The Inner Tube should be at least equal to the larger of the Outer Tube or Center Tube and no more than equal to 40% more wall thickness than the smallest of Outer Tube or Center Tube. Additionally, the Outer Tube and Center Tube should be no more than 15% different in wall thickness from one another.

In some embodiments, the Concentric Tubes can be made of steel alloy. Generally, the Outer Tube is at least 6% longer than both the Inner Tube and Center Tube. Therefore, one embodiment of the invention has the Outer Tube being 48 inches in length, while the Inner Tube and the Center Tube are 45.25 inches in length. The inner tube components are flush with the outer tube at the Ignition End of the rod.

When the Exothermic Cutting Rod is used an oxygen source pushes oxygen into the Torch End while also causing a chemical reaction that ignites the combustible materials. The oxygen will send the chemical reaction flowing through the spaces between the Concentric Tubes until it reaches the Ignition End where the chemical reaction is used for various purposes such as cutting through metal. This process is referred to as an Ignition Event.

In one test comparing the invention to that of one of another designed exothermic cutting rod, resulted in a 48% greater cut length, 15% increased use of PSI, 29% increase in cut speed, and a 47% increase in cut length versus rod length. The invention versus a wire in tube design resulted in a 30% decrease in oxygen use and a 25% decrease in cutting time (seconds per inch of material cut).

1. An Exothermic Cutting Rod Assembly, comprising:
a. A Concentric Tubes wherein said Concentric Tubes contains a Center Tube, an Inner Tube, and an Outer Tube; and
b. Wherein the Outer Tube having an Ignition End and a Torch End; and
c. Wherein the Center Tube is inside of the Inner Tube, and the Center Tube running parallel with the Inner Tube; and
d. Wherein the Center Tube and the Inner Tube are inside of the Outer Tube, and the Center Tube and the Inner Tube run parallel with the Outer Tube; and
e. Wherein the Center Tube, the Inner Tube, and the Outer Tube being crimped together in the form of a Tri-Point Pattern.

2. An Exothermic Cutting Rod Assembly as described in claim 1, comprising:
a. The Outer Tube and Center Tube which have a wall thickness of 0.028 inches to 0.032 inches; and
b. The Outer Tube and Center Tube having a wall thickness within 0.04 inches of one another; and
c. The Inner Tube which has a wall thickness of 0.031 inches to 0.039 inches; and
d. Wherein neither the Outer Tube nor the Center Tube have a greater wall thickness than the Inner Tube.

3. An Exothermic Cutting Rod Assembly as described in claim 1, comprising the Inner Tube having a wall thickness of no less than equivalent of the larger of the Outer Tube or the Center Tube, but no more than 40% greater wall thickness than the smaller of either the Outer Tube or the Center Tube.

4. An Exothermic Cutting Rod Assembly as described in claim 1, consisting of the Outer Tube and the Center Tube having being no more than 15% different in wall thickness from one another.

5. An Exothermic Cutting Rod Assembly as described in claim 1, comprising:
a. The Center Tube having an Outer Diameter of 0.275 inches to 0.290 inches; and
b. The Outer Tube having an Outer Diameter of 0.484 inches to 0.500 inches; and
c. The Inner Tube having an Outer Diameter of 0.378 inches to 0.393 inches.

6. An Exothermic Cutting Rod Assembly as described in claim 1, consisting of the Outer Tube having an Outer Diameter of 66.8% to 81.8% greater than the Outer Diameter of the Center Tube.

7. An Exothermic Cutting Rod Assembly as described in claim 1, consisting of the Outer Tube having an Outer Diameter of 30.3% to 42.9% greater than the Outer Diameter of the Inner Tube.

8. An Exothermic Cutting Rod Assembly as described in claim 1, comprising a space between the end of both the Inner Tube and Center Tube and the Torch End of the Outer Tube.

9. An Exothermic Cutting Rod Assembly as described in claim 1, comprising six Safety Crimps between the Concentric Tubes, with three Safety Crimps being an Outer Safety Crimp and three Safety Crimps being an Inner Safety Crimp.

10. An Exothermic Cutting Rod Assembly as described in claim 1, comprising of at least one set of six Place-Keeping Crimps between the Concentric Tubes, with three of the Place-Keeping Crimps in each set being an Outer Place-Keeping Crimp and the other three of the Place-Keeping Crimps in each set being an Inner Place-Keeping Crimp.

11. An Exothermic Cutting Rod Assembly, comprising:
a. A Center Tube
b. An Inner Tube; and
c. An Outer Tube;
d. Said Center Tube within the Inner Tube and the Inner Tube within the Outer Tube;
e. Wherein the Inner Tube and the Outer Tube are crimped together with three Outer Safety Crimps that are made in an equidistant fashion around the Outer Tube; and
f. Wherein the Inner Tube and the Center Tube are crimped together with three Inner Safety Crimps that are made in an equidistant fashion around the Inner Tube.
g. Said Center Tube is within the Inner Tube, and the Inner Tube is within the Outer Tube; and
h. Wherein the crimping allows air to flow between the crimps of the Outer Tube and Inner Tube, and also allows air to flow between the crimps of the Inner Tube and Center Tube, and also allows air to flow within the Center Tube; and
i. Wherein an amount of air is supplied to the Cutting Rod through the Torch End of the Concentric Tubes; and
j. Wherein the air combusts, allowing a Chemical Reaction and Oxygen to flow through the Center Tube, Inner Tube, and Outer Tube and out an Ignition End.
